(19) United States
(12) Patent Application Publication
(10) Pub. No.: US 2011/0298973 A1
(43) Pub. Date: Dec. 8, 2011

(54) IMAGE PROCESSING DEVICE AND METHOD, AND IMAGE DISPLAY DEVICE AND METHOD

(76) Inventors: Toshiaki KUBO, Tokyo (JP); Satoshi Yamanaka, Tokyo (JP); Koji Minami, Tokyo (JP); Yoshiki Ono, Tokyo (JP); Osamu Nasu, Tokyo (JP)

(21) Appl. No.: 13/151,524

(22) Filed: Jun. 2, 2011

(30) Foreign Application Priority Data
Jun. 3, 2010 (JP) 2010-127806

(51) Int. Cl. H04N 7/01

(52) U.S. Cl. 348/441; 348/E07.003

(57) ABSTRACT

To interpolate a frame between the current frame and a first delayed frame preceding the current frame, an image processing device generates test interpolation data for the first delayed frame from data in point-symmetric positions in the current frame and in a second delayed frame preceding the first delayed frame. Motion vectors pointing from the first delayed frame to the current frame are found by evaluating different test interpolation data against the actual data of the first delayed frame. These motion vectors are converted to pairs of motion vectors pointing from the first delayed frame and the current frame to the interpolated frame, and these pairs of motion vectors are used to generate accurate data for the interpolated frame from the data of the first delayed frame and the current frame.

### BACKGROUND OF THE INVENTION

1. Field of the Invention

The present invention relates to an image processing device and method, and to an image display device and method. More particularly, the invention relates to frame interpolation processing for the insertion of a newly interpolated frame between image frames.

2. Description of the Related Art

Liquid crystal displays and other displays of the hold type continue to display the same image for one frame period. A resulting problem is that the edges of moving objects in the image appear blurred, because although the human eye moves continuously while following a moving object, the moving object moves discontinuously, one frame at a time. One possible countermeasure is to smooth out the motion of the object by interpolating frames, thereby increasing the number of displayed frames.

A related problem, referred to as judder, occurs in content created by converting filmed footage such as a movie to a television signal. Because of the different frame rates of the two (the filmed footage and the television signal), two or three frames in the resulting image signal may have been created from the same original frame. If the image signal is displayed as is, motion appears blurred or jerky.

Similarly, when computer-processed images are converted to a television signal, two frames in the resulting image signal may have been created from the same frame, and if the image signal is displayed as is, the problem of judder occurs.

In conventional image processing devices and methods, one finds the zero-order hold method, which interpolates an image identical to the preceding frame, and the mean value method, in which the interpolated frame is the average of the preceding and following frames. The zero-order hold method, however, fails to produce smooth motion in an image that moves in a fixed direction, leaving the problem of blur in hold-type displays unsolved. With the mean value interpolation method, there is the problem that moving images look double.

An improved method is to generate each interpolated pixel in the interpolated frame from the most highly correlated pair of pixels in the preceding and following frames that are in point-symmetric positions with the interpolated pixel as the center of symmetry (as in Patent Document 1, for example). With this method, however, a large correlation between pixels in areas of quite different image content is sometimes detected, in which case a correctly interpolated frame cannot be generated.
Patent Document 1: Japanese Patent Application Publication No. 2006-129181

Conventional frame interpolation processing as described above is plagued by the problems of blurred or jerky motion. With methods that detect individual pixel correlations, there is a problem of inability to generate correctly interpolated frames because of inability to detect correlation correctly.

### SUMMARY OF THE INVENTION

A novel image processing device for interpolating a newly interpolated frame between data of a current frame of an image and data of a first delayed frame one frame before the current frame includes a motion vector detector for referring to the data of the current frame, the data of the first delayed frame, and data of a second delayed frame two frames before the current frame and calculating a first motion vector from the first delayed frame to the current frame, a motion vector converter for converting the first motion vector to a second motion vector from the first delayed frame to the interpolated frame and a third motion vector from the current frame to the interpolated frame, and an interpolated frame generator for generating data for the interpolated frame from the second motion vector, the third motion vector, the data of the first delayed frame, and the data of the current frame, and outputting image data in which the data of the interpolated frame are inserted between the data of the current frame and the data of the first delayed frame.

The motion vector detector includes a test interpolator for generating a plurality of test interpolation data from the data of the second delayed frame and the data of the current frame, an interpolation data evaluator for evaluating the plurality of test interpolation data on the basis of the data of the first delayed frame and outputting a plurality of evaluation data, and a motion vector determiner for generating the first motion vector on the basis of the plurality of evaluation data.

The present invention can interpolate frames without disrupting the image because, by regarding the middle frame of three temporally consecutive frames as the most reliable and evaluating motion vectors from the temporally preceding frame and the temporally following frame to the middle frame, it can calculate motion vectors with high precision.

### BRIEF DESCRIPTION OF THE DRAWINGS

In the attached drawings:

FIG. 1 is a block diagram showing the structure of an image processing device according to an embodiment of the invention.

FIG. 2 is a block diagram showing a specific example of the test interpolator 6, interpolation data evaluator 7, and motion vector determiner 8 in the motion vector detector 2 in FIG. 1.

FIG. 3 is a diagram for describing the operation of the motion vector detector 2 in FIG. 1.

FIG. 4 is a diagram illustrating the operations of the motion vector converter 3 and interpolated frame generator 4 in FIG. 1.

FIG. 5 is a diagram illustrating a correspondence between image data and data of the current frame, data of the first delayed frame, and data of the second delayed frame used in an example of the operation of the motion vector detector 2 in FIG. 1.

FIGS. 6A to 6E are diagrams showing an example of the operation of the motion vector detector 2 in FIG. 1.

FIGS. 7A and 7B are diagrams showing an example of the operation of the motion vector converter 3 in FIG. 1.

FIG. 8 is a diagram showing an example of the operation of the interpolated frame generator 4 in FIG. 1.

FIG. 9 is a flowchart showing the processing steps of an image display device according to the present embodiment.

### DETAILED DESCRIPTION OF THE INVENTION

An embodiment of the invention in which a novel image processing device interpolates data of a newly interpolated frame IF between the data of the current image frame F0 and the data of a frame F1 one frame before the current frame F0, frame F1 being the first delayed frame, will now be described with reference to the attached drawings, in which the novel image display device has an image display unit that displays the image data output from the image processing device.

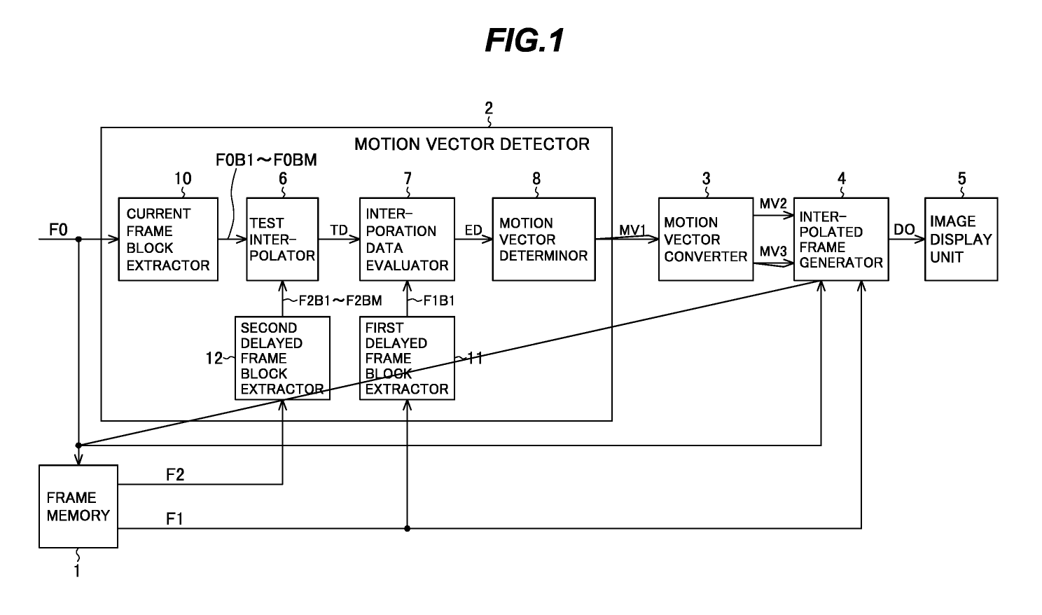

FIG. 1 is a block diagram showing the structure of the image display device according to the embodiment of the invention. The image display device according to the embodiment has a frame memory 1, a motion vector detector 2, a motion vector converter 3, an interpolated frame generator 4, and an image display unit 5.

Image data F0 are input to the frame memory 1, the motion vector detector 2, and the interpolated frame generator 4.

The frame memory 1 stores two frames of the image data F0 and outputs image data F1 delayed by one frame with respect to the image data F0 and image data F2 delayed by two frames with respect to the image data F0. Accordingly, the image data F0, F1, F2 are referred to as current frame data, first delayed frame data, and second delayed frame data, respectively. The current frame, the first delayed frame, and the second delayed frame are indicated by the same reference characters F0, F1, F2 as their frame data.

The data of the first delayed frame F1 are input to the motion vector detector 2 and the interpolated frame generator 4; the data of the second delayed frame F2 are input to the motion vector detector 2.

The motion vector detector 2 refers to the data of the current frame F0, the data of the first delayed frame F1, and the data of the second delayed frame, calculates a first motion vector MV1 from the first delayed frame F1 to the current frame F0 for each block (consisting of a plurality of pixels forming part of the frame) on the first delayed frame F1, and outputs the first motion vector MV1 to the motion vector converter 3.

The motion vector converter 3 converts the first motion vector MV1 to a second motion vector MV2 from the first delayed frame F1 to the interpolated frame IF and a third motion vector MV3 from the current frame F0 to the interpolated frame IF, and outputs the second and third motion vectors MV2, MV3 to the interpolated frame generator 4.

The interpolated frame generator 4 generates data for the interpolated frame IF positioned between the current frame F0 and the first delayed frame F1 from the data of the first delayed frame F1, the data of the current frame F0, the second motion vector MV2, and the third motion vector MV3, and outputs, to the image display unit 5, image data DO in which the generated data of the interpolated frame IF are inserted between the data of the current frame F0 and the data of the first delayed frame F1.

The image display unit 5 displays the image data DO.

Next, the structure of the motion vector detector 2 will be described in detail.

The motion vector detector 2 has a test interpolator 6, an interpolation data evaluator 7, a motion vector determiner 8, a current frame block extractor 10, a first delayed frame block extractor 11, and a second delayed frame block extractor 12.

The current frame block extractor 10, the first delayed frame block extractor 11, and the second delayed frame block extractor 12 each extract a block forming a part of a screen and output a set of pixel data (pixel values) within the block as block data. Each block forms a rectangular area having a size of, for example, X pixels in the horizontal direction and Y pixels (Y lines) in the vertical direction. That is, the block extracted from the current frame F0, the block extracted from the first delayed frame F1, and the block extracted from the second delayed frame F2 are mutually equal in size (in number of pixels) in the horizontal direction and size (number of pixels or number of lines) in the vertical direction.

The current frame block extractor 10 extracts blocks from the current frame F0, the first delayed frame block extractor 11 extracts blocks from the first delayed frame F1, and the second delayed frame block extractor 12 extracts blocks from the second delayed frame F2.

The process performed to generate one block in the interpolated frame IF by interpolation will be described below. The following blocks are extracted for this process: one block in the first delayed frame F1 corresponding to the block to be interpolated in the interpolated frame IF; a plurality of blocks in the current frame F0; and a plurality of blocks in the second delayed frame F2. The blocks extracted from the current frame F0 and the blocks extracted from the second delayed frame F2 are in point-symmetric positions with respect to the block (more precisely, the center position of the block) in the first delayed frame F1, which is taken as the center of symmetry, and are used as pairs. That is, the current frame block extractor 10 and the second delayed frame block extractor 12 extract a plurality of pairs of blocks centered on the block in the first delayed frame F1, where in each pair, one block is disposed in the current frame F0 and the other block is disposed in the second delayed frame F2.

The pairs of blocks extracted from the current frame F0 and second delayed frame F2 correspond to motion vector candidates detected in the motion vector detector 2 so, for example, all blocks within a motion vector search area are extracted. When an area centered on the center position of the block in the first delayed frame F1, measuring ±HS pixels in the horizontal direction and ±VS pixels (±VS lines) in the vertical direction, is searched, for example, (2HS+1)×(2VS+1) blocks are extracted from each of the second delayed frame F2 and the current frame F0.

When all blocks in the search area do not have to be evaluated, for example, when the range of direction of the motion is predictable in advance or from other information, only the blocks in the predicted range within the search area may be extracted. Alternatively, a sparse set of blocks in the search area (centered, for example, at every other pixel in the horizontal and vertical directions) may be extracted.

The number of blocks extracted from the current frame F0 and the second delayed frame F2 is assumed to be M below: the first to M-th blocks extracted from the current frame F0 are referred to as F0B1 to F0BM; the first to M-th blocks extracted from the second delayed frame F2 are referred to as F2B1 to F2BM. The data of each block are indicated by the same reference character as used for the block.

The m-th block F2Bm (m=1 to M) in the second delayed frame F2 and the m-th block F0Bm in the current frame F0 are in point-symmetric positions with the block F1B1 (more precisely, the pixel at the center of that block) in the first delayed frame F1 taken as the center of symmetry. Therefore, if block F2Bm is shifted with respect to block F1B1 by h horizontally (h=−HS to +HS) and v vertically (v=−VS to +VS), block F0Bm shifts by −h horizontally and −v vertically with respect to block F1B1.

The current frame block extractor 10 extracts a plurality of blocks, i.e., first to M-th blocks, from the current frame and outputs first to M-th block data F0B1 to F0BM.

The first delayed frame block extractor 11 extracts block F1B1 from the first delayed frame. Block F1B1 corresponds to the block to be interpolated in the interpolated frame IF.

The second delayed frame block extractor 12 extracts a plurality of blocks, i.e., first to M-th blocks, from the second delayed frame and outputs first to M-th block data F2B1 to F2BM.

The block data of the current frame F0 and the block data of the second delayed frame F2 are input to the test interpolator 6. The test interpolator 6 generates test interpolation data from the block data of the second delayed frame F2 and the block data of the current frame F0 on the basis of block pairs consisting of a block in the second delayed frame F2 and a block in the current frame F0 that are in point-symmetric positions with block F1B1 in the first delayed frame F1 taken as the center of symmetry. A plurality of test interpolation data are generated on the basis of a plurality of block pairs. This test interpolation is performed on the assumption that the data at the center position of the point-symmetry, that is, the data of block F1B1 in the first delayed frame F1, are unknown, so that as the accuracy of interpolation increases, the test interpolation data have a higher correlation with the data of the block F1B1.

The interpolation data evaluator 7 refers to the block data of the first delayed frame F1 to evaluate the plurality of test interpolation data and outputs evaluation data ED to the motion vector determiner 8. In this evaluation, a correlation between the test interpolation data and the block data of the first delayed frame F1 is obtained and a higher evaluation is given to a higher correlation.

The motion vector determiner 8 generates and outputs the first motion vector MV1 according to the evaluation data ED.

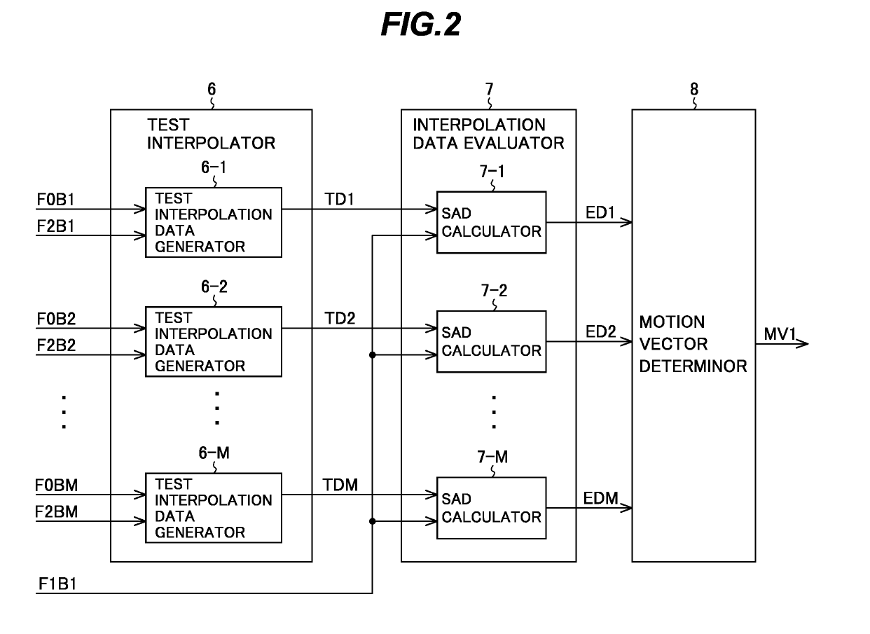

Next, a specific example of the test interpolator 6, interpolation data evaluator 7, and motion vector determiner 8 in the motion vector detector 2 will be described in detail with reference to FIG. 2.

The test interpolator 6 is depicted as having a plurality of test interpolation data generators, i.e., first to M-th test interpolation data generators 6-1 to 6-M. The interpolation data evaluator 7 is depicted as having a plurality of sum of absolute differences (SAD) calculators, i.e., first to M-th sum of absolute differences calculators 7-1 to 7-M.

The test interpolation data generators 6-1 to 6-M calculate, as test interpolation data TD1 to TDM, the data of average values obtained by averaging the block data F0B1 to F0BM of the current frame F0 and the respective paired block data F2B1 to F2BM of the second delayed frame F2 on a per-pixel basis. In FIG. 1, the set of test interpolation data TD1 to TDM is indicated by reference characters TD.

A more detailed description will now be given.

The first block data F0B1 of the current frame F0 and the first block data F2B1 of the second delayed frame F2 are input to the test interpolation data generator 6-1.

As the first test interpolation data TD1, the test interpolation data generator 6-1 outputs to the sum of absolute differences calculator 7-1 the per-pixel average values of the first block data F0B1 of the current frame F0 and the first block data F2B1 of the second delayed frame F2. Per-pixel average means, herein, the average of the value of a pixel in a block in the current frame F0 and the value of the pixel at the corresponding position in a block in the second delayed frame (for example, the value of the pixel represented by the same coordinate values referenced to a reference position such as, for example, the upper-left corner of each of the blocks as an origin position).

Similarly, the second block data F0B2 of the current frame F0 and the second block data F2B2 of the second delayed frame F2 are input to the test interpolation data generator 6-2. The test interpolation data generator 6-2 outputs the per-pixel average values of the second block data F0B2 of the current frame F0 and the second block data F2B2 of the second delayed frame F2 to the sum of absolute differences calculator 7-2 as the second test interpolation data TD2.

The test interpolation data generators 6-3 to 6-M similarly generate, and output to the sum of absolute differences calculators 7-3 to 7-M, third test interpolation data TD3 to M-th test interpolation data TDM on the basis of the third block data F0B3 to the M-th block data F0BM of the current frame F0 and the third block data F2B3 to the M-th block data F2BM of the second delayed frame F2.

To generalize, the test interpolation data generator 6-m generates the m-th test interpolation data TDm on the basis of the m-th block data F0Bm of the current frame F0 and the m-th block data F2Bm of the second delayed frame F2 and outputs the m-th test interpolation data TDm to the sum of absolute differences calculator 7-m (m=1 to M).

The block data F1B1 of the first delayed frame F1 are input to the sum of absolute differences calculators 7-1 to 7-M in the interpolation data evaluator 7.

The sum of absolute differences calculators 7-1 to 7-M calculate a sum of absolute differences between each of the test interpolation data TD1 to TDM output from the test interpolator 6 and the block data F1B1 of the first delayed frame F1, and output the results as evaluation data ED1 to EDM.

The sum of absolute differences calculator 7-1 calculates the sum of the absolute values of the differences between the data of each pixel constituting the first test interpolation data TD1 and the data of each pixel constituting the block data F1B1 of the first delayed frame F1, and outputs the result to the motion vector determiner 8 as evaluation data ED1. The sum of absolute differences is expressed by the following equation (1).

$$SAD = {\sum }_{y = 0}^{Y - 1} {\sum }_{x = 0}^{X - 1} \vert BK 1 ( x , y ) - BK 2 ( x , y ) \vert \qquad ( 1 )$$

The smaller the value of the sum of absolute differences given by equation (1) is, the higher the correlation is, so when the sum of absolute differences SAD is used as evaluation data, smaller values indicates higher evaluations.

In the above equation (1), BK1 and BK2 indicate the data of the pixels in the blocks: BK1 indicates the data of the pixels constituting test interpolation data TD1; BK2 indicates the data of the pixels in block F1B1. Therefore, equation (1) gives the sum of absolute differences between the data of the pixels constituting the first test interpolation data TD1 and the data of the pixels constituting the block data F1B1 of the first delayed frame F1. This sum of absolute differences SAD is output from the sum of absolute differences calculator 7-1 as evaluation data ED1.

Similarly, the sum of absolute differences calculators 7-2 to 7-M calculate the sum of absolute differences between the second test interpolation data TD2 to the M-th test interpolation data TDM and the block data F1B1 of the first delayed frame F1, and output the results to the motion vector determiner 8 as evaluation data ED2 to EDM.

As motion vector MV1, the motion vector determiner 8 outputs one-half the location difference between a block in the current frame F0 and a block in the second delayed frame F2 (one-half the relative position of the block in the current frame F0 with respect to the block in the second delayed frame F2), these blocks constituting the block pair corresponding to the evaluation data having the highest evaluation (the smallest sum of absolute differences) among the evaluation data ED1 to EDM.

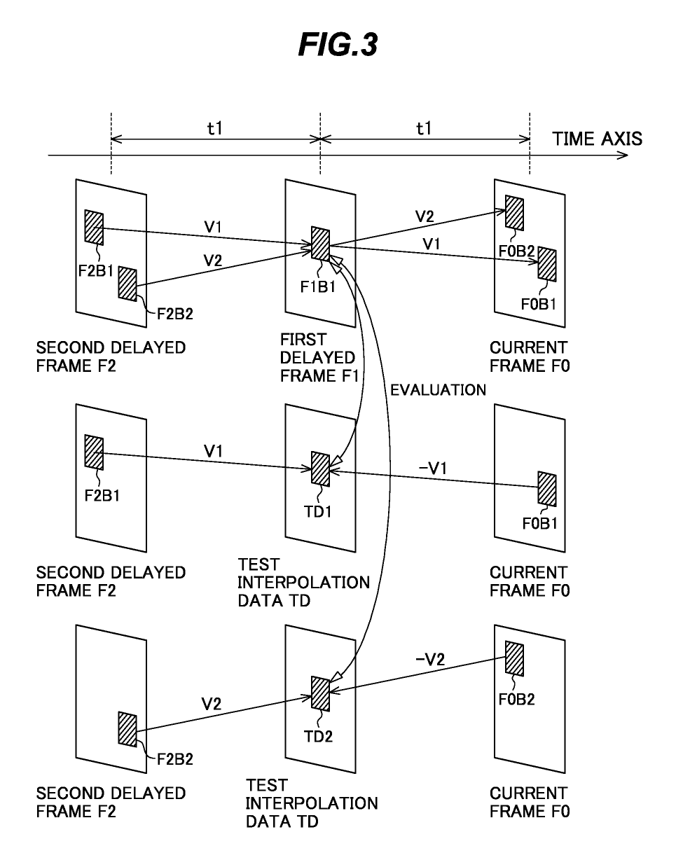

FIG. 3 is a diagram illustrating the operation of the motion vector detector 2 when M=2.

A subregion of the first delayed frame F1 is extracted as the block data F1B1 of the first delayed frame F1.

A region corresponding to a position shifted by a vector −V1 with respect to the block data F1B1 of the first delayed frame F1 is set and extracted as the first block data F2B1 of the second delayed frame F2; the region corresponding to the position shifted by the vector +V1 is set and extracted as the first block data F0B1 of the current frame F0.

A region corresponding to a position shifted by a vector −V2 with respect to the block data F1B1 of the first delayed frame F1 is set and extracted as the second block data F2B2 of the second delayed frame F2; the region corresponding to the position shifted by the vector +V2 is set and extracted as the second block data F0B2 of the current frame F0.

The test interpolation data generator 6-1 generates test interpolation data TD1 by averaging the first block data F0B1 of the current frame F0 and the first block data F2B1 of the second delayed frame F2 on a per-pixel basis.

Similarly, the test interpolation data generator 6-2 generates test interpolation data TD2 by averaging the second block data F0B2 of the current frame F0 and the second block data F2B2 of the second delayed frame F2 on a per-pixel basis.

The sum of absolute differences calculator 7-1 calculates the sum of absolute differences SAD from test interpolation data TD1 and the block data F1B1 of the first delayed frame F1 by using equation (1) and outputs the result as evaluation data ED1.

Similarly, the sum of absolute differences calculator 7-2 calculates the sum of absolute differences SAD from test interpolation data TD2 and the block data F1B1 of the first delayed frame F1 by using equation (1) and outputs the result as evaluation data ED2.

As the motion vector MV1, the motion vector determiner 8 outputs the shift (+V1 or +V2) between the blocks forming the block pair that generates the smaller of the evaluation data ED1 and ED2. If evaluation data ED1 is smaller than evaluation data ED2, for example, vector V1 is output as motion vector MV1.

A method of determining the first motion vector from two vectors has been described in FIG. 3, but the structure of this embodiment of the invention is not limited to M=2. That is, three or more vectors may be set as candidates. For example, test interpolation may be performed for all blocks in the second delayed frame that are located in a search area corresponding to a predetermined amount of motion with respect to the block F1B1 in the first delayed frame, and for the blocks in the current frame that are located at point-symmetric positions thereto.

The motion vector detector 2 determines the motion vector by evaluating the vector candidates by using the actual data in the first delayed frame F1 as described above, making it possible to calculate an accurate motion vector from the current frame F0 to the first delayed frame F1.

The sum of absolute differences was used to calculate the evaluation data in the interpolation data evaluator 7, but it can be replaced with one of many other available correlation calculation functions, such as, for example, the sum of the squared error.

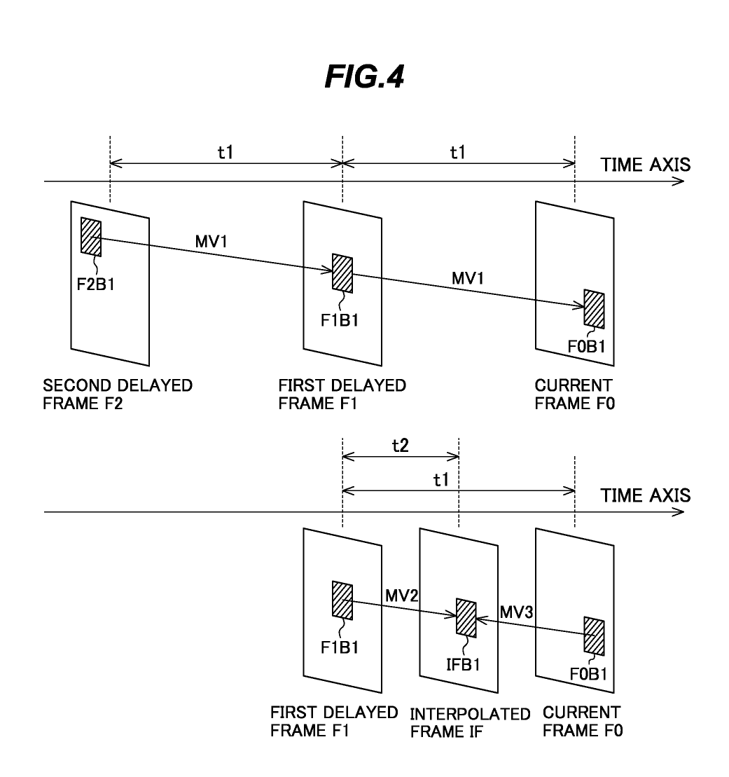

Next, the operation of the motion vector converter 3 and the interpolated frame generator 4 will be described in detail with reference to FIG. 4.

The motion vector converter 3 converts the motion vector MV1 from the first delayed frame F1 to the current frame F0 to a second motion vector MV2 from the first delayed frame F1 to the interpolated frame IF and a third motion vector MV3 from the current frame F0 to the interpolated frame IF.

If the time interval between input frames is denoted t1 and the time interval from the first delayed frame F1 to the interpolated frame IF is denoted t2 as shown in FIG. 4, the motion vectors MV2, MV3 are calculated by the following equations (2A), (2B). When a 60-Hz input image signal is converted to a 120-Hz image signal, for example, t1 is 1/60 seconds and t2 is 1/120 seconds.

MV2=MV1×t2/t1 (2A)

MV3=−MV1×(t1−t2)/t1 (2B)

These conversions can be regarded as using a process that apportions the vector MV1 from the first delayed frame F1 to the current frame F0 according to the time intervals (t2, t1-t2) between the first delayed frame F1 and the interpolated frame IF and between the interpolated frame IF and the current frame F0.

After the second and third vectors MV2, MV3 are obtained in this way, as the data of the interpolated frame IF, averages are calculated between the data of the first delayed frame F1 at positions shifted by the vector −MV2 from the interpolated frame (the data in block F1B1) and the data of the current frame F0 at positions shifted by the vector −MV3 from the interpolated frame (the data in block F0B1). The data used for interpolation, in this case block data F1B1 in the first delayed frame F1 and block data F0B1 in the current frame F0, are in mutually symmetric positions centered on the position of the data to be obtained by interpolation in the interpolated frame IF.

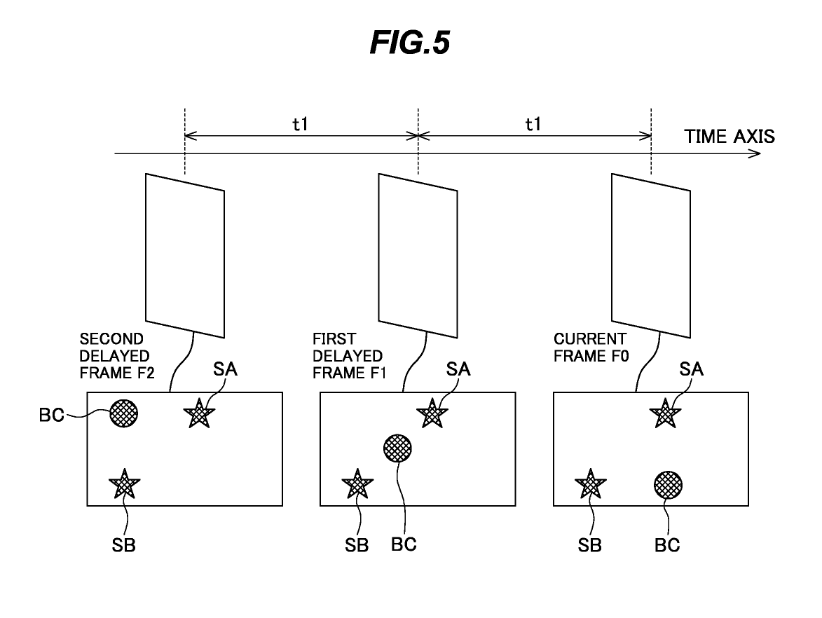

FIG. 5 is a diagram illustrating the correspondence among data of the current frame F0, data of the first delayed frame F1, and data of the second delayed frame F2 which are used in an example of the operation of the motion vector detector 2. The operation of the present embodiment when signals representing video images such as the ones shown in FIG. 5 are input will be described. In the video images shown in FIG. 5, a cross-hatched circle BC moves from the upper left to the lower right over time, while cross-hatched stars SA, SB remain stationary.

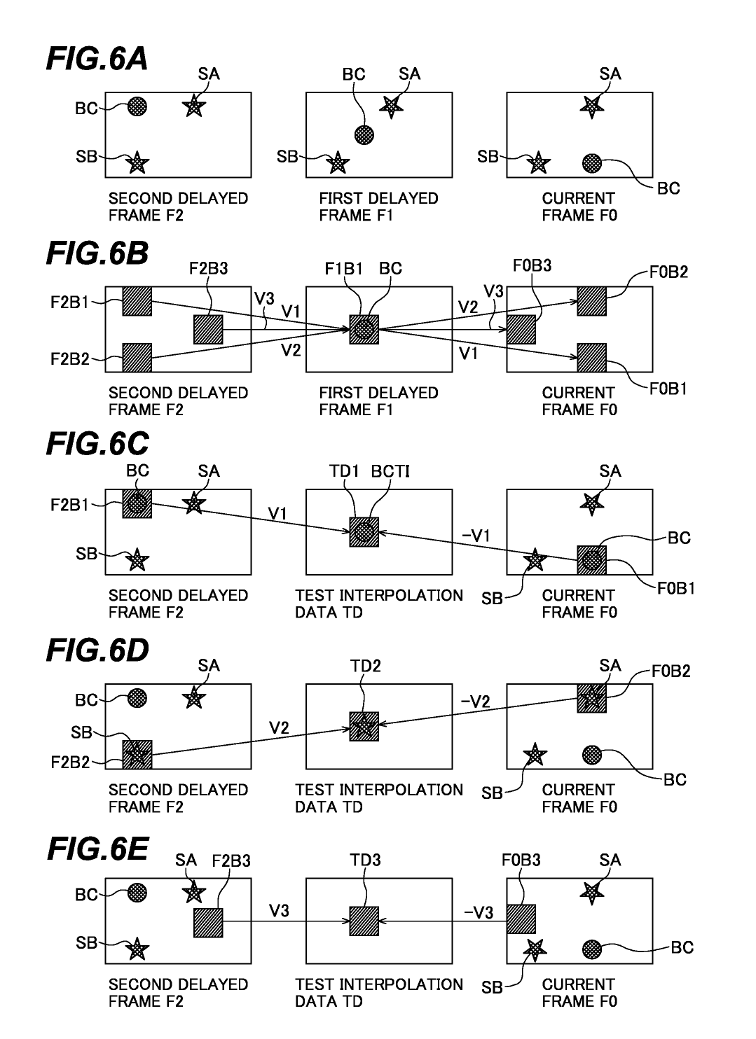

FIGS. 6A to 6E are diagrams showing an example of the operation of the motion vector detector 2: FIG. 6A shows exemplary image data input to the motion vector detector 2; FIGS. 6B to 6E illustrate the operation of the test interpolator 6 and interpolation data evaluator 7.

The operation of the motion vector detector 2 performed when the data of the second delayed frame F2, first delayed frame F1, and current frame F0 shown in FIG. 6A are input will now be described.

The test interpolator 6 generates test interpolation data for each motion vector. As shown in FIG. 6B, a subregion of the first delayed frame F1 is set as block data F1B1 in the first delayed frame F1; block data in the second delayed frame F2 at a position shifted by −V1 from the block data F1B1 of the first delayed frame F1 are set as first block data F2B1; block data in the current frame F0 at a position shifted by V1 from the block data F1B1 of the first delayed frame F1 are set as block data F0B1. Further block data in the second delayed frame F2 at a position shifted by −V2 from the block data F1B1 of the first delayed frame F1 are set as a block data F2B2; block data in the current frame F0 at a position shifted by V2 from the block data F1B1 of the first delayed frame F1 are set as block data F0B2. Block data in the second delayed frame F2 at a position shifted by −V3 from the block data F1B1 of the first delayed frame F1 are set as block data F2B3; block data in the current frame F0 at a position shifted by V3 from the block data F1B1 of the first delayed frame F1 are set as block data F0B3.

As shown in FIG. 6C, per-pixel averages are generated from the first block data F2B1 and block data F0B1 as test interpolation data TD1. FIG. 6C shows that the image represented by test interpolation data TD1 includes a circle BCTI. Test interpolation data TD2, TD3 are generated similarly as shown in FIGS. 6D and 6E.

The interpolation data evaluator 7 calculates the sum of absolute differences between block data F1B1 and each of the test interpolation data TD1 to TD3 shown in FIGS. 6C to 6E and outputs evaluation data ED1 to ED3. In the specific example in FIGS. 6A to 6E, the image represented by test interpolation data TD1, which includes the cross-hatched circle BC, has the smallest sum of absolute differences from block data F1B1 and therefore has the smallest evaluation data ED1.

The motion vector determiner 8 outputs the motion vector V1 corresponding to the smallest evaluation data ED1 among the evaluation data ED1 to ED3 as the motion vector of data block F1B1.

By setting blocks on the first delayed frame F1 without leaving gaps and calculating motion vectors, first motion vectors MV1 are generated for all areas on the first delayed frame F1. That is, the first delayed frame F1 is divided into a plurality of, for example, blocks of mutually identical size, and the above process is performed on each of the blocks, thereby generating first motion vectors MV1 for the blocks. By using the first motion vectors and performing a conversion, second and third motion vectors can then be obtained for blocks in the interpolated frame located at positions corresponding to, e.g., identical to, the positions of the blocks in the first delayed frame F1.

Alternatively, the above process may be performed on blocks of a predetermined size centered on each pixel in the first delayed frame, thereby generating a first motion vector MV1 for each pixel, so that by using the first motion vectors and performing a conversion, second and third motion vectors can then be obtained for the pixels in the interpolated frame located at the positions corresponding to, e.g., identical to, the positions of the pixels in the first delayed frame.

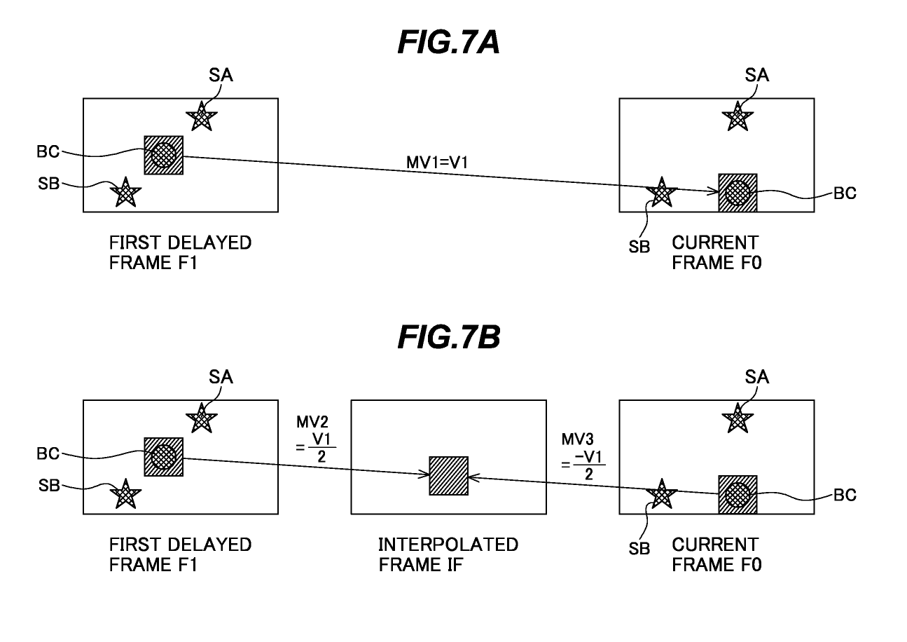

FIGS. 7A and 7B are diagrams showing an example of the operation of the motion vector converter 3: FIG. 7A shows inputs to the motion vector converter 3; FIG. 7B shows outputs from the motion vector converter 3.

Using equations (2A), (2b) and assuming t2=t1/2, the motion vector converter 3 converts the motion vector MV1 from the first delayed frame F1 to the current frame F0, shown in FIG. 7A, into a second motion vector MV2 from the first delayed frame F1 to the interpolated frame IF and a third motion vector MV3 from the current frame F0 to the interpolated frame IF as shown in FIG. 7B. In the example shown in FIGS. 7A and 7B, MV1 equals V1, t1 equals 1/60 seconds, and t2 equals 1/120 seconds, so from equations (2A) and (2B), MV2 becomes V1/2 and MV3 becomes −V1/2.

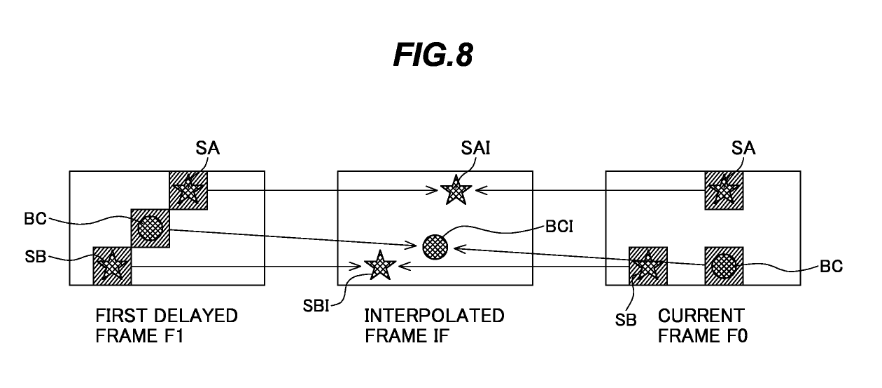

FIG. 8 is a diagram showing an example of the operation of the interpolated frame generator 4. As shown in FIG. 8, the interpolated frame generator 4 calculates, as the data of the interpolated frame IF, the averages of the data of the first delayed frame F1 at positions shifted by −MV2 from the interpolated frame IF and the data of the current frame F0 at positions shifted by −MV3 from the interpolated frame IF. The generated interpolated frame IF is interpolated and output between the first delayed frame F1 and the current frame F0. FIG. 8 shows the interpolated frame IF as including a circle BCI generated from the circle BC in the first delayed frame F1 and the circle BC in the current frame F0, a star SAI generated from the star SA in the first delayed frame F1 and the star SA in the current frame F0, and a star SBI generated from the star SB in the first delayed frame F1 and the star SB in the current frame F0.

As described above, by evaluating motion vectors, the present embodiment can detect motion vectors accurately and can interpolate interpolated frames without disrupting the image.

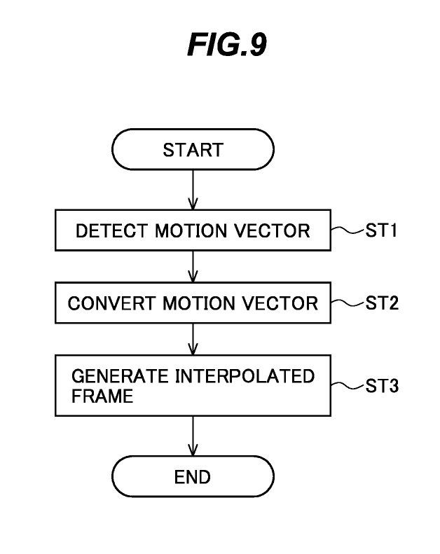

FIG. 9 is a flowchart showing the processing steps of the above-described image display device according to the present embodiment.

First, in a motion vector detection step ST1, first motion vectors MV1 from the first delayed frame F1 to the current frame F0 are generated with reference to the image data F0, the image data F1 delayed by one frame from the image data F0, and the image data F2 delayed by two frames from the image data F0. This operation is equivalent to the motion vector detector 2.

In a motion vector conversion step ST2, the first motion vectors MV1 are converted to second motion vectors MV2 from the first delayed frame F1 to the interpolated frame IF (which is inserted between the current frame F0 and the first delayed frame F1) and third motion vectors MV3 from the current frame F0 to the interpolated frame IF. This operation is equivalent to the motion vector converter 3.

In an interpolated frame generation step ST3, the data of the interpolated frame IF are generated from the data of the first delayed frame F1, the data of the current frame F0, the second motion vectors MV2, and the third motion vectors MV3, and image data DO are generated in which the data of the generated interpolated frame IF are inserted between the data of the current frame F0 and the data of the first delayed frame F1. This operation is equivalent to the interpolated frame generator 4.

In FIG. 9 part of the image display device according to the present embodiment is implemented as software, so the effect is the same.

A few variations of the preceding embodiment have been mentioned above, but those skilled in the art will recognize that further variations are possible within the scope of the invention, which is defined in the appended claims.

What is claimed is:

1. An image processing device for interpolating a newly interpolated frame between data of a current frame of an image and data of a first delayed frame one frame before the current frame, comprising:
a motion vector detector for referring to the data of the current frame, the data of the first delayed frame, and data of a second delayed frame two frames before the current frame, and calculating a first motion vector from the first delayed frame to the current frame;
a motion vector converter for converting the first motion vector to a second motion vector from the first delayed frame to the interpolated frame and a third motion vector from the current frame to the interpolated frame; and
an interpolated frame generator for generating data for the interpolated frame from the second motion vector, the third motion vector, the data of the first delayed frame, and the data of the current frame, and outputting image data in which the data of the interpolated frame are inserted between the data of the current frame and the data of the first delayed frame; wherein
the motion vector detector includes
a test interpolator for generating a plurality of test interpolation data from the data of the second delayed frame and the data of the current frame,
an interpolation data evaluator for evaluating the plurality of test interpolation data on a basis of the data of the first delayed frame and outputting a plurality of evaluation data, and
a motion vector determiner for generating the first motion vector on a basis of the plurality of evaluation data.

2. The image processing device of claim 1, wherein the test interpolator generates the test interpolation data on a basis of data of a block consisting of a plurality of pixels in the second delayed frame and a block consisting of a plurality of pixels in the current frame that are in point-symmetric positions with respect to a block consisting of a plurality of pixels in the first delayed frame taken as a center of symmetry.

3. The image processing device of claim 2, wherein the interpolation data evaluator calculates a correlation between the test interpolation data output from the test interpolator and the data of the block in the first delayed frame taken as the center of symmetry.

4. The image processing device of claim 3, wherein the interpolation data evaluator calculates, as the correlation, a sum of absolute differences of the data of pixels at mutually corresponding positions in the blocks.

5. The image processing device of claim 1, wherein the test interpolator includes a plurality of test interpolation data generators for calculating, as the test interpolation data, block data in which the block data in the current frame and the block data in the second delayed frame are averaged on a per-pixel basis.

6. The image processing device of claim 5, wherein the interpolation data evaluator includes a plurality of sum of absolute differences calculators for calculating a sum of absolute differences between the test interpolation data output from the test interpolation data generators and the data of the block in the first delayed frame.

7. An image display device comprising:
the image processing device of claim 1; and
an image display unit for displaying the image data output from the interpolated frame generator.

8. An image processing method for interpolating a newly interpolated frame between data of a current frame of an image and data of a first delayed frame one frame before the current frame, comprising:
a motion vector detection step for referring to the data of the current frame, the data of the first delayed frame, and data of a second delayed frame two frames before the current frame, and calculating a first motion vector from the first delayed frame to the current frame;
a motion vector conversion step for converting the first motion vector to a second motion vector from the first delayed frame to the interpolated frame and a third motion vector from the current frame to the interpolated frame; and
an interpolated frame generation step for generating data for the interpolated frame from the second motion vector, the third motion vector, the data of the first delayed frame, and the data of the current frame, and outputting image data in which the data of the interpolated frame are inserted between the data of the current frame and the data of the first delayed frame; wherein
the motion vector detection step includes
a test interpolation step for generating a plurality of test interpolation data from the data of the second delayed frame and the data of the current frame,
an interpolation data evaluation step for evaluating the plurality of test interpolation data on a basis of the data of the first delayed frame and outputting a plurality of evaluation data, and
a motion vector determination step for generating the first motion vector on a basis of the plurality of evaluation data.

9. The image processing method of claim 8, wherein the test interpolation step generates the test interpolation data on a basis of data of a block consisting of a plurality of pixels in the second delayed frame and a block consisting of a plurality of pixels in the current frame that are in point-symmetric positions with respect to a block consisting of a plurality of pixels in the first delayed frame taken as the center of symmetry.

10. The image processing method of claim 9, wherein the interpolation data evaluation step calculates a correlation between the test interpolation data output from the test interpolation step and the data of the block in the first delayed frame taken as the center of symmetry.

11. The image processing method of claim 10, wherein the interpolation data evaluation step calculates, as the correlation, a sum of absolute differences of the data of pixels at mutually corresponding positions in the blocks.

12. The image processing method of claim 8, wherein the test interpolation step includes a plurality of test interpolation data generation steps for calculating, as the test interpolation data, block data in which the block data in the current frame and the block data in the second delayed frame are averaged on a per-pixel basis.

13. The image processing method of claim 12, wherein the interpolation data evaluation step includes a plurality of sum of absolute differences calculation steps for calculating the sum of absolute differences between the test interpolation data output from the test interpolation data generation steps and the data of the block in the first delayed frame.

14. An image display method comprising:
the image processing method of claim 8; and
an image display step for displaying the image data output from the interpolated frame generation step.
